(19) United States
(12) Patent Application Publication
(10) Pub. No.: US 2024/0131739 A1
(43) Pub. Date: Apr. 25, 2024

(54) RAZOR HANDLE

(71) Applicant: BIC Violex Single Member S.A., Anoixi (GR)

(72) Inventor: Argyro KALLIVRETAKI, Anoixi (GR)

(73) Assignee: BIC Violex Single Member S.A., Anoixi (GR)

(21) Appl. No.: 18/488,598

(22) Filed: Oct. 16, 2023

(30) Foreign Application Priority Data
Oct. 19, 2022 (EP) 22202745.0

(51) Int. Cl. B26B 21/52

(52) U.S. Cl. CPC B26B 21/522; B26B 21/528

(57) ABSTRACT

The present disclosure relates to a razor handle comprising a first section disposed in proximal direction of a second section along a proximal-distal axis, wherein a ball bearing is disposed between the first section and the second section, wherein the ball bearing is configured to allow rotation of the first section relative to the second section around the proximal-distal axis.

### CROSS REFERENCE TO RELATED APPLICATION

This application claims benefit from European patent application EP 22202745.0 filed on Oct. 20, 2022, its content being incorporated herein by reference.

### TECHNICAL FIELD

The present disclosure relates to the field of razors. More specifically, the present disclosure relates to razor handles comprising ball bearings.

### BACKGROUND

Razors are well known everyday items to shave of unwanted bodily hair, e.g. beard hairs. The razor may comprise a razor cartridge including blades configured to cut the hair and a razor handle used attached thereto. In use, a user holds the razor handle and brings the razor cartridge into contact with a portion of skin. By movement of the razor handle the razor cartridge moves in a shaving direction and unwanted hair is removed.

However, in some inaccessible areas of the body, for example the back of the legs, it may be difficult for the user to perform the shaving action, in particular due to difficult holding angles leading to poor handling. The poor handling may cause discomfort to the user. Additionally, the difficulties in shaving inaccessible areas of the body may lead to poor shaving results, e.g. remainder of excessive stubbles or completely missed regions of unwanted hair. Further, the poor handling may increase the risk of the user cutting his or her skin and the risk for razor burn.

The present disclosure aims to address the aforementioned issues in optimizing razor connectors.

### SUMMARY

In a first aspect, the present disclosure relates to a razor handle comprising a first section disposed in proximal direction of a second section along a proximal-distal axis, wherein a ball bearing is disposed between the first section and the second section, wherein the ball bearing is configured to allow rotation of the first section relative to the second section around the proximal-distal axis.

In some embodiments, the first section may be integrally formed with a first part of the ball bearing and/or wherein the second section may be integrally formed with a second part of the ball bearing.

In some embodiments, the first part of the ball bearing may comprise a first bearing race of the ball bearing and the second part of the ball bearing may comprise a second bearing race of the ball bearing, or wherein the second part of the ball bearing may comprise the first bearing race of the ball bearing and the first part of the ball bearing may comprise the second bearing race of the ball bearing.

In some embodiments, the second bearing race may be disposed closer to the proximal-distal axis relative to the first bearing race.

In some embodiments, the razor handle may comprise a rotation limiter, wherein the rotation limiter may be configured to limit the maximum degree of relative rotation of the first section relative to the second section.

In some embodiments, the rotation limiter may be formed of a first protrusion extending from the first bearing race in radial direction towards the proximal-distal axis and a second protrusion extending from the second bearing race in radial direction away from the proximal-distal axis.

In some embodiments, the rotation limiter may comprise a third protrusion, wherein the third protrusion extends from the first bearing race in radial direction towards the proximal-distal axis, wherein the second protrusion may be disposed in circumferential direction between the first and third protrusion; or, wherein the third protrusion extends from the second bearing race in radial direction away from the proximal-distal axis, wherein the first protrusion may be disposed in circumferential direction between the second and third protrusion.

In some embodiments, the razor handle may comprise a biasing mechanism, wherein the biasing mechanism may be configured to rotate the first section relative to the second section towards a home position.

In some embodiments, a first part of the biasing mechanism may be connected to the first bearing race and a second part of the biasing mechanism may be connected to the second bearing race, wherein the second part of the biasing mechanism may comprise a fourth protrusion extending from the first section towards the proximal-distal axis into a recess disposed within the first part of the biasing mechanism.

In some embodiments, the fourth protrusion may be flexible.

In some embodiments, the razor handle may comprise a plurality of layers, more specifically wherein the first section and the second section may comprise a plurality of layers.

In some embodiments, a layer of the plurality of layers may have a thickness between about 5 μm to about 100 μm, more specifically between about 10 μm to about 50 μm and in particular between about 15 μm to about 30 μm.

In some embodiments, a layer of the plurality of layers may have a thickness between about 0.05 mm to about 0.6 mm, more specifically between about 0.1 μm to about 0.4 mm and in particular between about 0.15 mm to about 0.3 mm.

In some embodiments, the razor handle may be characterized by being manufactured by additive manufacturing. Exemplary additive manufacturing techniques that could be used include, but are not limited to, extrusion methods such as fused deposition modeling (FDM), electron beam freeform fabrication (EBF), direct metal laser sintering (DMLS), electron-beam melting (EBM), selective laser melting (SLM), selective heat sintering (SHS), selective laser sintering (SLS), plaster-based 3D printing, laminated object manufacturing (LOM), stereolithography (SLA), and digital light processing (DLP).

In some embodiments, the razor handle may comprise a first polymer, more specifically a photopolymer and in particular an ABS-like polymer and/or polypropylene-like polymer.

In some embodiments, the first polymer may have a Shore D hardness between about 50 to about 120, more specifically between about 55 to about 100 and in particular between about 60 to about 90, measured according to ISO 868:2003.

In some embodiments, the razor handle may comprise a second polymer, more specifically a thermoplastic polymer and in particular ABS and/or polypropylene.

In some embodiments, the second polymer may have a Shore D hardness between about 50 to about 120, more specifically between about 55 to about 100 and in particular between about 60 to about 90, measured according to ISO 868:2003.

A razor system comprising a razor handle according to any preceding claim and a razor cartridge, wherein the razor cartridge may be releasably attached to the razor handle, in particular via a pivotable connection or a non-pivotable connection.

A razor system comprising a razor handle according to any preceding claim and a razor cartridge, wherein the razor cartridge may be integrally formed with the razor handle, in particular via a pivotable connection or a non-pivotable connection.

The razor system according to any preceding claim, wherein the razor system further may comprise a razor connector connected to the razor handle, wherein the razor connector may be configured to fasten the razor cartridge to the razor handle.

In a second aspect, the present disclosure relates to a method for manufacturing a razor handle according to the first aspect. The method according to the second aspect comprises manufacturing the razor handle using a computer-controlled manufacturing system, in particular additive manufacturing, even more particularly material jetting, fused filament fabrication, stereolithography and/or selective laser sintering.

In a third aspect, the present disclosure relates to a computer-based manufacturing system for manufacturing a razor handle, comprising a control unit adapted to execute the method according to the second aspect.

In a fourth aspect, the present disclosure relates to a computer program comprising computer readable code which cause a computer-based manufacturing system to carry out the steps according to the first aspect.

In a fifth aspect, the present disclosure relates to a computer readable medium comprising the computer readable code according to the first aspect.

In a sixth aspect, the present disclosure relates to a model of the razor handle according to the first aspect for a computer-controlled manufacturing system, wherein the model is configured to be processed by the computer-controlled manufacturing system to manufacture the razor handle.

In a seventh aspect, the present disclosure relates to a computer-readable medium, wherein the computer-readable medium comprises instructions configured to be processed by a computer-controlled manufacturing system to manufacture the razor handle according to the first aspect.

### DESCRIPTION OF THE DRAWINGS

FIG. 1 shows a razor handle 10 with a ball bearing 16 according to the present disclosure.

FIG. 2 shows a cross-sectional view of razor handle 10 with a ball bearing 16 according to the present disclosure.

FIG. 3 shows a cross-sectional view of a ball bearing 16 according to the present disclosure.

FIG. 4 shows a biasing mechanism according to the present disclosure.

FIG. 5 shows a rotation limiter according to the present disclosure.

### DETAILED DESCRIPTION

Hereinafter, a detailed description will be given of the present disclosure. The terms or words used in the description and the aspects of the present disclosure are not to be construed limitedly as only having common-language or dictionary meanings and should, unless specifically defined otherwise in the following description, be interpreted as having their ordinary technical meaning as established in the relevant technical field. The detailed description will refer to specific embodiments to better illustrate the present disclosure, however, it should be understood that the presented disclosure is not limited to these specific embodiments.

For an improved grip by the user, razors may comprise gripping portions comprising ergonomic handles and/or anti-slip surfaces to improve the handling. However, when shaving more inaccessible regions of the body, e.g. the back of the legs, the user may not be able to properly grip the handle of the razor due to holding angle. As a result, the user may have less control over the razor.

Accordingly, in a first aspect, the present disclosure relates to a razor handle comprising a first section 12 disposed in proximal direction of a second section 14 along a proximal-distal axis 28, wherein a ball bearing 16 is disposed between the first section 12 and the second section 14, wherein the ball bearing 16 is configured to allow rotation of the first section 12 relative to the second section 14 around the proximal-distal axis 28.

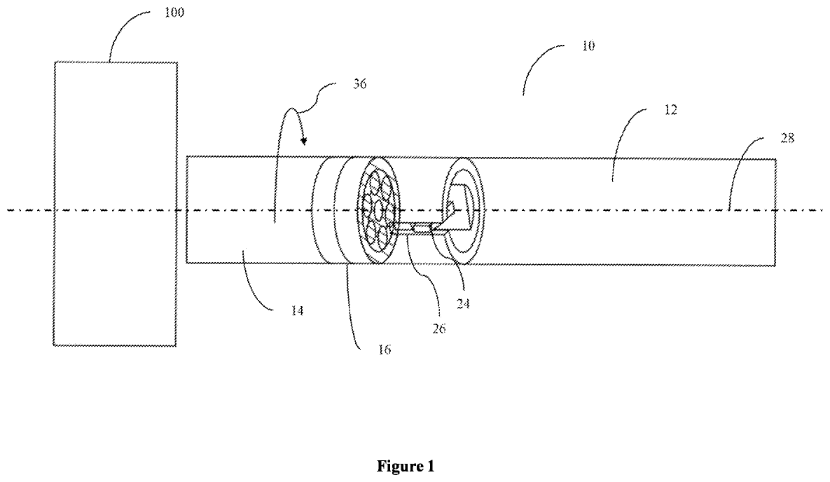

For example, as schematically illustrated in FIG. 1, the second section 14 may comprise a razor connector configured to attach to a razor cartridge 100. The first section 12 may comprise a gripping portion configured to be grabbed by the user. The user may first shave a first part of the body, e.g. the front side of the legs with the first and second section 14 aligned at first angle, in particular with a secure grip on the gripping portion. Subsequently, the user may rotate the first section 12 relative to the second section 14 to shave the back side of the legs, which enables the user to still have secure grip on the gripping portion.

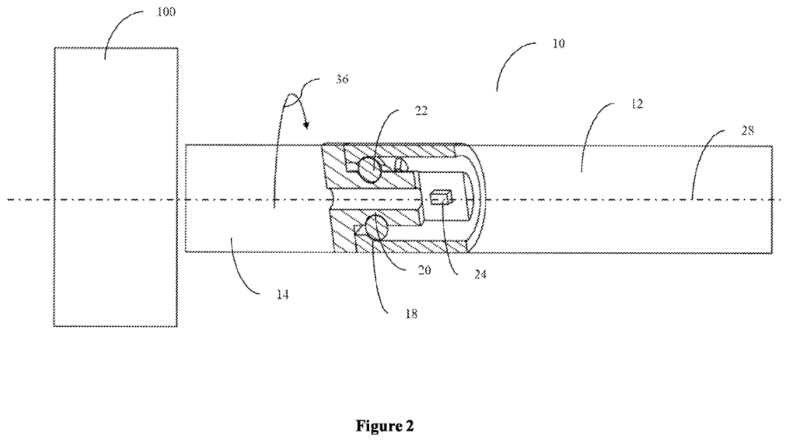

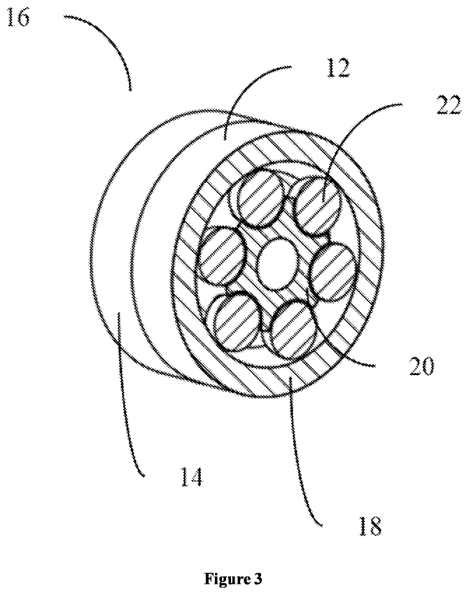

The inclusion of a ball bearing 16 into a razor handle may increase the number of parts of the razor and thereby assembly time of the razor handle. Accordingly, in some embodiments, the first section 12 may be integrally formed with a first part of the ball bearing 16 and/or wherein the second section 14 may be integrally formed with a second part of the ball bearing 16. The first 12 and/or second section 14 may be integrally formed with the ball bearing 16 for example by additively manufacturing the razor handle. As depicted in FIG. 2 and FIG. 3, the first part of the ball bearing 16 may comprise a first bearing race 18 of the ball bearing 16 and the second part of the ball bearing 16 may comprise a second bearing race 20 of the ball bearing 16. Between the first bearing race 18 and the second bearing race 20, a plurality of bearing balls 22 may be disposed. The term “bearing race” within this disclosure may i.a. (inter alia) refer to its common meaning in the art. Additionally or alternatively, the term “bearing race” may refer to structure upon which bearing balls are configured to roll. Additionally or alternatively, the term “bearing race” may refer to a structure configured to allow the bearing balls to roll along a predefined path. Additionally or alternatively, the term “bearing race” may refer to a ring comprising a circumferential groove. In examples, the second part of the ball bearing may comprise the first bearing race of the ball bearing and the first part of the ball bearing may comprise the second bearing race of the ball bearing.

In some embodiments, as depicted in FIGS. 2 and 3, the second bearing race 20 may be disposed closer to the proximal-distal axis 28 relative to the first bearing race 18. Hence, the second bearing race 20 may be the inner bearing race of the ball bearing 16.

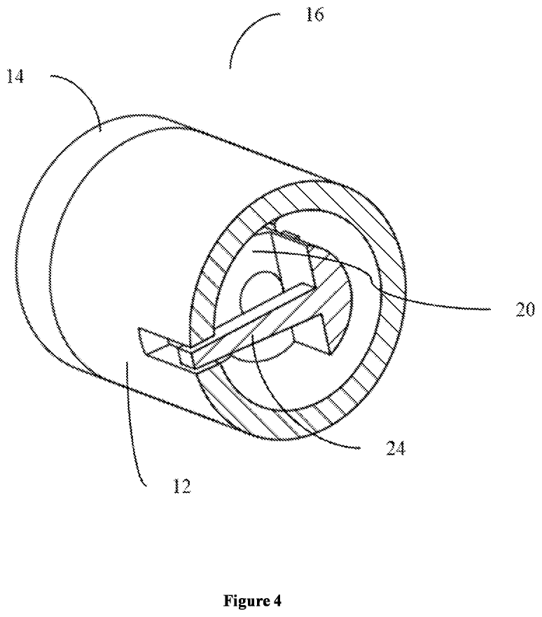

To provide improved handling of the razor, it may, in some instances, be advantageous to bias the razor handle 10 towards a home position. Accordingly, in some embodiments, the razor handle may comprise a biasing mechanism, wherein the biasing mechanism may be configured to rotate the first section 12 relative to the second section 14 towards a home position. The home position may be for example the relative angle of the first section 12 relative to the second section 14 which would be used to shave the front of the legs. The biasing mechanism may exert a biasing force onto the first section 12 and second section 14 to bias these towards the home position. In some embodiments, a first part of the biasing mechanism may be connected to the first bearing race 18 and a second part of the biasing mechanism may be connected to the second bearing race 20, wherein the second part of the biasing mechanism may comprise a fourth protrusion 24 extending from the first section 12 towards the proximal-distal axis 28 into a recess 26 disposed within the first part of the biasing mechanism, as depicted in FIG. 1 and FIG. 4. In some embodiments, the fourth protrusion 24 may be flexible. The flexibility of the fourth protrusion 24 may provide the biasing force which rotates the first section 12 relative to the second section 14 towards a home position. The fourth protrusion 24 may be “rod-shaped”. The biasing mechanism may also improve the handling of the razor handle 10 by providing a force pressing against the user's skin during use, compared to a first section 12 and second section 14 being allowed to rotate completely freely.

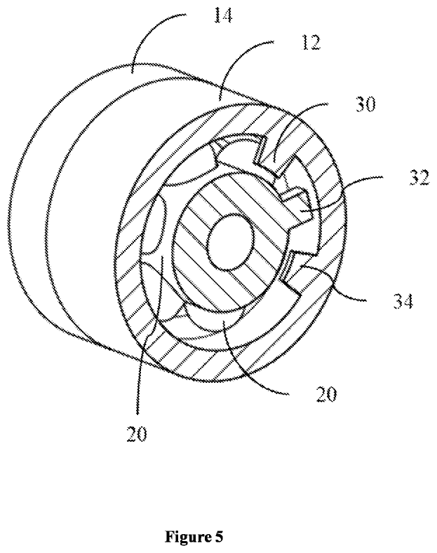

Alternatively or additionally, the razor handle 10 may comprise a rotation limiter, wherein the rotation limiter may be configured to limit the maximum degree of relative rotation of the first section 12 relative to the second section 14. The degrees of relative rotation may be for example +/−15°. The rotation limiter may prevent the first section 12 and second section 14 to rotate towards unergonomic or uncomfortable for the user angles. Additionally, the rotation limiter may prevent damage to other parts of the razor handle. For example, at great relative rotation of the first section 12 relative to the second section 14, the fourth protrusion 24 may break. In some embodiments, the rotation limiter may be formed of a first protrusion 30 extending adjacent to the first bearing race 18 in radial direction towards the proximal-distal axis 28 and a second protrusion 32 extending adjacent to the second bearing race 20 in radial direction away from the proximal-distal axis 28. In some embodiments, as depicted in FIG. 5, the rotation limiter may comprise a third protrusion 34, wherein the third protrusion 34 extends from the first bearing race 18 in radial direction towards the proximal-distal axis 28, wherein the second protrusion 32 may be disposed in circumferential direction between the first 30 and third protrusion 34; or, wherein the third protrusion 34 extends from the second bearing race 20 in radial direction away from the proximal-distal axis 28, wherein the first protrusion 30 may be disposed in circumferential direction between the second and third protrusion 34.

In some embodiments, the razor handle may be characterized by being manufactured by additive manufacturing.

In some embodiments, the razor handle may comprise a plurality of layers, more specifically wherein the first section 12 and the second section 14 may comprise a plurality of layers. Additive manufacturing technologies, such as fused filament fabrication or material jetting may lead to a plurality of layers, in particular a plurality of layers substantially parallel to each other.

In some embodiments, a layer of the plurality of layers may have a thickness between about 5 μm to about 100 μm, more specifically between about 10 μm to about 50 μm and in particular between about 15 μm to about 30 μm. In some embodiments, a layer of the plurality of layers may have a thickness between about 0.05 mm to about 0.6 mm, more specifically between about 0.1 μm to about 0.4 mm and in particular between about 0.15 mm to about 0.3 mm.

The thickness of the plurality of layers may depend upon the process used for manufacturing. Further, a smaller layer thickness may lead to an increased manufacturing time of the razor handle but may also increase the mechanical stability and dimensional accuracy of the razor handle.

In some embodiments, the razor handle may comprise a first polymer, more specifically a photopolymer and in particular an ABS-like polymer and/or polypropylene-like polymer. A photopolymer and in particular an ABS-like polymer and/or polypropylene-like polymer may be processable by an additive manufacturing process such as stereolithography. The first polymer may have a Shore D hardness between about 50 to about 120, more specifically between about 55 to about 100 and in particular between about 60 to about 90, measured according to ISO 868:2003. The first polymer may be for example Durus or Rigur, by the company Stratasys, Ltd.

In some embodiments, the razor handle may comprise a second polymer, more specifically a thermoplastic polymer and in particular ABS and/or polypropylene. Alternatively or additionally, the first or second polymer may comprise a self-lubricating polymer. The self-lubricating polymer may be for example PTFE-Additionally or alternatively, the self-lubricating polymer may comprise a lubricating filler, for example molybdenum disulfide, graphene and/or copper oxide, in particular in nanosheet-form.

In some embodiments, the second polymer may have a Shore D hardness between about 50 to about 120, more specifically between about 55 to about 100 and in particular between about 60 to about 90, measured according to ISO 868:2003. The ball bearing may comprise the first or second polymer. In particular the first bearing race 18, second bearing race 20 and/or the plurality of balls 22 may comprise the first or second polymer.

Thermoplastic elastomers, as well as ABS and/or polypropylene may be processable by technologies wherein a solid material is liquified and subsequently resolidified for manufacturing, for example extrusion. Thermoplastic elastomers, as well as ABS and/or polypropylene may in particular be processable by additive manufacturing technologies such as fused filament fabrication and/or selective laser melting.

Additive manufacturing technologies may also be employed as multi-material processes, wherein a one-piece part comprising at least two different materials can be manufactured. For example, stereolithography and fused filament fabrication may be used to create multi-material parts. In fused filament fabrication the manufacturing device, e.g. the 3D-printer, may comprise multiple nozzles, wherein each nozzle is configured to extrude a different polymer. In stereolithography the part to be produced may change between vats comprising different precursors. Hence, additive manufacturing may be employed to optimize properties of certain parts and/or regions of the razor connector 10 by varying the choice of material locally.

In embodiments, the razor connector 10 may comprise a third polymer. The third polymer may have a shore A hardness between about 10 to about 95, more specifically between about 25 to about 80 and in particular between about 35 to about 60, measured according to ASTM D2240-15. The third polymer may be for example Tango or Agilus 30, by the company Stratasys, Ltd. In embodiments, the razor connector 10 may comprise a fourth polymer, more specifically a thermoplastic elastomer and in particular a TPA, a TPC, a TPO, a TPS, a TPV, a TPZ and/or a TPU. The third and/or fourth polymer may have a lower modulus of elasticity compared to the first and/or second polymer. A material with a lower modulus of elasticity exhibits a higher degree of deformation when exposed to the same force compared to a material with a higher modulus of elasticity. The third and/or fourth polymer may have a lower hardness, in particular shore A and/or shore D hardness, compared to the first and/or second polymer, which may allow for a higher degree of deformation of the third and/or fourth compared to the first and/or second polymer when exposed to the same force. Hence, the fourth protrusion 24 may comprise the third or fourth polymer, in particular as these may provide the fourth protrusion 24 with flexibility.

A razor system comprising a razor handle according to any preceding claim and a razor cartridge 100, wherein the razor cartridge 100 may be releasably attached to the razor handle, in particular via a pivotable connection or a non-pivotable connection.

A razor system comprising a razor handle according to any preceding claim and a razor cartridge 100, wherein the razor cartridge 100 may be integrally formed with the razor handle, in particular via a pivotable connection or a non-pivotable connection.

The razor system according to any preceding claim, wherein the razor system further may comprise a razor connector connected to the razor handle, wherein the razor connector may be configured to fasten the razor cartridge 100 to the razor handle.

In a second aspect, the present disclosure relates to a method for manufacturing a razor handle according to the first aspect. The method according to the second aspect comprises manufacturing the razor handle using a computer-controlled manufacturing system, in particular additive manufacturing, material jetting, fused filament fabrication, stereolithography and/or selective laser sintering.

Further, the aspects relate to provisions for controlling additive manufacturing devices, as well as processing information related to manufacturing the razor handle 10.

In a third aspect, the present disclosure relates to a computer-based manufacturing system for manufacturing a razor handle, comprising a control unit adapted to execute the method according to the second aspect.

The computer-based manufacturing system may comprise viewing interface (e.g., a monitor or screen), input devices (e.g., keyboard and/or mouse), and software for designing a computer-aided design (“CAD”) representation of a three-dimensional model. In at least some embodiments, the CAD representation can provide a model of the razor handle 10. In some embodiments, computer-based manufacturing system may be in direct contact with one or more devices or systems of additive manufacturing device via network. The network may include any wired or wireless provisions that facilitate the exchange of information between computer-based manufacturing system and additive manufacturing device. In some embodiments, network may further include various components such as network interface controllers, repeaters, hubs, bridges, switches, routers, modems, and firewalls. In some cases, the network may be a wireless network that facilitates wireless communication between two or more systems, devices, and/or components of additive manufacturing device. Examples of wireless networks include, but are not limited to, wireless personal area networks (including, for example, Bluetooth), wireless local area networks (including networks utilizing the IEEE 802.11 WLAN standards), wireless mesh networks, mobile device networks as well as other kinds of wireless networks. In other cases, the network could be a wired network including networks whose signals are facilitated by twister pair wires, coaxial cables, and optical fibers. In still other cases, a combination of wired and wireless networks and/or connections could be used. A user may use a CAD system (e.g., CAD software) to design a customized path for a razor handle 10. Embodiments may utilize any standard CAD or other software tool to design a particular model of the razor handle 10.

Once a desired contoured path for the razor handle has been designed, a user may submit the razor handle design to the additive manufacturing device for manufacturing. In some cases, information related to the razor handle can be provided to additive manufacturing device in the form of a computer readable code, such as a 3D printing file format. In one embodiment, for example, the razor handle design and/or information associated with the razor handle design could be provided to the additive manufacturing device in an STL file format, which is a Stereolithography file format for 3D printing. In other embodiments, the information could be stored and/or transferred in the Additive Manufacturing File Format (AMF), which is an open standard for 3D printing information. Still other embodiments could store and/or transfer information using the X3D file format. In still other embodiments, any other file formats known for storing 3D objects and/or 3D printing information could be used.

In a fourth aspect, the present disclosure relates to a computer program comprising computer readable code which cause a computer-based manufacturing system to carry out the method according to the second aspect.

In a fifth aspect, the present disclosure relates to a computer readable medium comprising the computer readable code according to the fourth aspect.

In a sixth aspect, the present disclosure relates to a model of the razor handle according to the first aspect for a computer-controlled manufacturing system, wherein the model is configured to be processed by the computer-controlled manufacturing system to manufacture the razor handle.

In a seventh aspect, the present disclosure relates to a computer-readable medium, wherein the computer-readable medium comprises instructions configured to be processed by a computer-controlled manufacturing system to manufacture the razor handle according to the first aspect.

Although the present disclosure is defined in the attached claims, it should be understood that the present disclosure can also be defined in accordance with the following aspects:

### Embodiments

1. A razor handle (10) comprising a first section (12) disposed in proximal direction of a second section (14) along a proximal-distal axis (28),
   wherein a ball bearing (16) is disposed between the first section (12) and the second section (14),
   wherein the ball bearing (16) is configured to allow rotation of the first section (12) relative to the second section (14) around the proximal-distal axis (28).
2. The razor handle (10) according to embodiment 1, wherein the first section (12) is integrally formed with a first part of the ball bearing (16) and/or wherein the second section (14) is integrally formed with a second part of the ball bearing (16).
3. The razor handle (10) according to embodiment 2, wherein the first part of the ball bearing (16) comprises a first bearing race (18) of the ball bearing (16) and the second part of the ball bearing (16) comprises a second bearing race (20) of the ball bearing (16), or
   wherein the second part of the ball bearing (16) comprises the first bearing race (18) of the ball bearing (16) and the first part of the ball bearing (16) comprises the second bearing race (20) of the ball bearing (16).
4. The razor handle (10) according to embodiment 3, wherein the second bearing race (20) is disposed closer to the proximal-distal axis (28) relative to the first bearing race (18).
5. The razor handle (10) according to any preceding embodiment, wherein the razor handle (10) comprises a rotation limiter, wherein the rotation limiter is configured to limit the maximum degree of relative rotation of the first section (12) relative to the second section (14).
6. The razor handle (10) according to embodiment 5, wherein the rotation limiter is formed of a first protrusion (30) extending adjacent to the first bearing race (18) in radial direction towards the proximal-distal axis (28) and a second protrusion (32) extending adjacent to the second bearing race (20) in radial direction away from the proximal-distal axis (28).
7. The razor handle (10) according to embodiment 6, wherein the rotation limiter comprises a third protrusion (34),
   wherein the third protrusion (34) extends from the first bearing race (18) in radial direction towards the proximal-distal axis (28), wherein the second protrusion (32) is disposed in circumferential direction between the first and third protrusion (34); or,
   wherein the third protrusion (34) extends from the second bearing race (20) in radial direction away from the proximal-distal axis (28), wherein the first protrusion (30) is disposed in circumferential direction between the second and third protrusion (34).
8. The razor handle (10) according to any preceding embodiment, wherein the razor handle (10) comprises a biasing mechanism, wherein the biasing mechanism is configured to rotate the first section (12) relative to the second section (14) towards a home position.
9. The razor handle (10) according to embodiment 8, wherein a first part of the biasing mechanism is connected to the first bearing race (18) and a second part of the biasing mechanism is connected to the second bearing race (20), wherein the second part of the biasing mechanism comprises a fourth protrusion (24) extending from the first section (12) towards the proximal-distal axis (28) into a recess (26) disposed within the first part of the biasing mechanism.
10. The razor handle (10) according to embodiment 9, wherein the fourth protrusion (24) is flexible.
11. The razor handle (10) according to any preceding embodiment, wherein the razor handle (10) comprises a plurality of layers, more specifically wherein the first section (12) and the second section (14) comprise a plurality of layers.
12. The razor handle (10) according to embodiment 11, wherein a layer of the plurality of layers has a thickness between about 5 μm to about 100 μm, more specifically between about 10 μm to about 50 μm and in particular between about 15 μm to about 30 μm.
13. The razor handle (10) according to embodiment 11, wherein a layer of the plurality of layers has a thickness between about 0.05 mm to about 0.6 mm, more specifically between about 0.1 μm to about 0.4 mm and in particular between about 0.15 mm to about 0.3 mm.
14. The razor handle (10) according to any preceding embodiment, wherein the razor handle (10) is characterized by being manufactured by additive manufacturing.
15. The razor handle (10) according to any preceding embodiment, wherein the razor handle (10) comprises a first polymer, more specifically a photopolymer and in particular an ABS-like polymer and/or polypropylene-like polymer.
16. The razor handle (10) according to embodiment 15, wherein the first polymer has a Shore D hardness between about 50 to about 120, more specifically between about 55 to about 100 and in particular between about 60 to about 90, measured according to ISO 868:2003.
17. The razor handle (10) according to any preceding embodiment, wherein the razor handle (10) comprises a second polymer, more specifically a thermoplastic polymer and in particular ABS and/or polypropylene.
18. The razor handle (10) according to embodiment 17, wherein the second polymer has a Shore D hardness between about 50 to about 120, more specifically between about 55 to about 100 and in particular between about 60 to about 90, measured according to ISO 868:2003.
19. A razor system comprising a razor handle (10) according to any preceding embodiment and a razor cartridge, wherein the razor cartridge is releasably attached to the razor handle (10), in particular via a pivotable connection or a non-pivotable connection.
20. A razor system comprising a razor handle (10) according to any one of embodiments 1 to 18 and a razor cartridge, wherein the razor cartridge is integrally formed with the razor handle (10), in particular via a pivotable connection or a non-pivotable connection.
21. The razor system according to embodiment 20, wherein the razor system further comprises a razor connector connected to the razor handle (10), wherein the razor connector is configured to fasten the razor cartridge to the razor handle (10).
22. A method for manufacturing a razor handle (10) according to any one of embodiments 1 to 18 comprising:
   manufacturing the razor handle (10) using a computer-controlled manufacturing system, in particular additive manufacturing, in particular material jetting, fused filament fabrication, stereolithography and/or selective laser sintering.
23. A computer-based manufacturing system for manufacturing a razor handle (10), comprising a control unit adapted to execute the method according to embodiment 22.
24. A computer program comprising computer readable code which cause a computer-based manufacturing system to carry out the steps according to embodiment 22.
25. A computer readable medium comprising the computer readable code according to embodiment 24.
26. A model of the razor handle (10) according to any one of embodiments 1 to 18 for a computer-controlled manufacturing system, wherein the model is configured to be processed by the computer-controlled manufacturing system to manufacture the razor handle (10).
27. A computer-readable medium, wherein the computer-readable medium comprises instructions configured to be processed by a computer-controlled manufacturing system to manufacture the razor handle (10) according to any one of embodiments 1 to 18.

1. A razor handle comprising a first section disposed in proximal direction of a second section along a proximal-distal axis, wherein a ball bearing is disposed between the first section and the second section, wherein the ball bearing is configured to allow rotation of the first section relative to the second section around the proximal-distal axis.

2. The razor handle according to claim 1, wherein the first section is integrally formed with a first part of the ball bearing and/or wherein the second section is integrally formed with a second part of the ball bearing.

3. The razor handle according to claim 2, wherein the first part of the ball bearing comprises a first bearing race of the ball bearing and the second part of the ball bearing comprises a second bearing race of the ball bearing, or
wherein the second part of the ball bearing comprises the first bearing race of the ball bearing and the first part of the ball bearing comprises the second bearing race of the ball bearing.

4. The razor handle according to claim 3, wherein the second bearing race is disposed closer to the proximal-distal axis relative to the first bearing race.

5. The razor handle according to claim 1, wherein the razor handle comprises a rotation limiter, wherein the rotation limiter is configured to limit the maximum degree of relative rotation of the first section relative to the second section.

6. The razor handle according to claim 5, wherein the rotation limiter is formed of a first protrusion extending adjacent to the first bearing race in radial direction towards the proximal-distal axis and a second protrusion extending adjacent to the second bearing race in radial direction away from the proximal-distal axis.

7. The razor handle according to claim 6, wherein the rotation limiter comprises a third protrusion, wherein the third protrusion extends from the first bearing race in radial direction towards the proximal-distal axis, wherein the second protrusion is disposed in circumferential direction between the first and third protrusion; or,
wherein the third protrusion extends from the second bearing race in radial direction away from the proximal-distal axis, wherein the first protrusion is disposed in circumferential direction between the second and third protrusion.

8. The razor handle according to claim 1, wherein the razor handle comprises a biasing mechanism, wherein the biasing mechanism is configured to rotate the first section relative to the second section towards a home position.

9. The razor handle according to claim 8, wherein a first part of the biasing mechanism is connected to the first bearing race and a second part of the biasing mechanism is connected to the second bearing race, wherein the second part of the biasing mechanism comprises a fourth protrusion extending from the first section towards the proximal-distal axis into a recess disposed within the first part of the biasing mechanism.

10. The razor handle according to claim 9, wherein the fourth protrusion is flexible.

11. The razor handle according to claim 1, wherein the razor handle comprises a plurality of layers, more specifically wherein the first section and the second section comprises a plurality of layers.

12. The razor handle according to claim 11, wherein a layer of the plurality of layers has a thickness between about 5 μm to about 100 μm, more specifically between about 10 μm to about 50 μm and in particular between about 15 μm to about 30 μm.

13. A razor system comprising a razor handle according to claim 1 and a razor cartridge, wherein the razor cartridge is releasably attached to the razor handle, in particular via a pivotable connection or a non-pivotable connection.

14. A razor system comprising a razor handle according to claim 1 and a razor cartridge, wherein the razor cartridge is integrally formed with the razor handle, in particular via a pivotable connection or a non-pivotable connection.

15. The razor system according to claim 14, wherein the razor system further comprises a razor connector connected to the razor handle, wherein the razor connector is configured to fasten the razor cartridge to the razor handle.

16. A razor system comprising a razor handle according to claim 1 and a razor cartridge, wherein the razor cartridge is releasably attached to the razor handle, in particular via a pivotable connection or a non-pivotable connection.

17. A method for manufacturing a razor handle according to claim 1 comprising:
manufacturing the razor handle using a computer-controlled manufacturing system, in particular additive manufacturing, even more particularly material jetting, fused filament fabrication, stereolithography and/or selective laser sintering.

18. A computer-based manufacturing system for manufacturing a razor handle, comprising a control unit adapted to execute the method according to claim 17.

19. A computer program comprising computer readable code which cause a computer-based manufacturing system to carry out the steps according to the method of claim 13.

20. A model of the razor handle according to claim 1 for a computer-controlled manufacturing system, wherein the model is configured to be processed by the computer-controlled manufacturing system to manufacture the razor handle.
